(19) United States
(12) Patent Application Publication
(10) Pub. No.: US 2020/0389872 A1
(43) Pub. Date: Dec. 10, 2020

(54) USER TERMINAL AND RADIO COMMUNICATION METHOD

(71) Applicant: NTT DOCOMO, INC., Tokyo (JP)

(72) Inventors: Ryosuke Osawa, Tokyo (JP); Yuichi Kakishima, Tokyo (JP)

(73) Assignee: NTT DOCOMO, INC., Tokyo (JP)

(21) Appl. No.: 16/644,405

(22) PCT Filed: Sep. 11, 2017
(86) PCT No.: PCT/JP2017/032716

§ 371 Date: Mar. 4, 2020

(51) Int. Cl. H04W 72/04; H04W 72/12; H04L 5/00; H04W 28/06

(52) U.S. Cl. CPC H04W 72/042; H04W 72/0413; H04W 28/06; H04L 5/0053; H04W 72/12

(57) ABSTRACT

In accordance with one aspect of the present disclosure, a user terminal has a receiving section that receives downlink control information, a transmission section that transmits an uplink signal based on the downlink control information, and a control section that changes interpretation of a specific field, included in the downlink control information, depending on whether a waveform to apply to the uplink signal has already been indicated or not. According to one aspect of the present disclosure, it is possible to reduce the decline in communication throughput even when a number of waveforms are switched around and used.

### TECHNICAL FIELD

The present disclosure relates to a user terminal and a radio communication method in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower latency and so on (see non-patent literature 1). In addition, the specifications of LTE-A (LTE-advanced and LTE Rel. 10, 11, 12 and 13) have also been drafted for the purpose of achieving increased capacity and enhancement beyond LTE (LTE Rel. 8 and 9).

Successor systems of LTE are also under study (for example, referred to as “FRA (Future Radio Access),” “5G (5th Generation mobile communication system),” “5G+(plus),” “NR (New Radio),” “NX (New radio access),” “FX (Future generation radio access),” “LTE Rel. 14 or 15 and later versions,” etc.).

In LTE, a codebook refers to a predetermined candidate for a precoding matrix. For example, a user terminal (UE (User Equipment)) selects a precoding matrix that will increase throughput, from a codebook, based on a signal transmitted from a base station (referred to as, for example, an “eNB (evolved Node B),” a “BS (Base Station),” etc.), and transmits its index (PMI (Precoding Matrix Indicator)) as feedback. After that, the base station applies precoding to signals to transmit to the UE, based on the received PMI.

Also, the base station controls data allocation (scheduling) for the UE. The base station reports downlink control information (DCI) that show data scheduling commands, to the UE, by using a downlink control channel (for example, PDCCH (Physical Downlink Control CHannel)). For example, when a UE conforming to existing LTE (for example, LTE Rel. 8 to 13) receives DCI that commands UL transmission (and that is also referred to as a “UL grant”), the UE transmits UL data in a subframe that is located a predetermined period later (for example, 4 ms later).

### CITATION LIST

### Non-Patent Literature

Non-Patent Literature 1: 3GPP TS36.300 V8.12.0 “Evolved Universal Terrestrial Radio Access (E-UTRA) and Evolved Universal Terrestrial Radio Access Network (E-UTRAN); Overall Description; Stage 2 (Release 8),” April, 2010

### SUMMARY OF INVENTION

### Technical Problem

Envisaging future radio communication systems (for example, NR), for example, research is underway to support waveforms that are based on two types of communication schemes for the uplink. In addition, a field to indicate the waveform may be introduced in a UL grant.

However, if a field to indicate the waveform is contained in UL grants at all times, there is a problem that the amount of communication related to signaling will increase, and the throughput of communication will deteriorate.

The present invention has been made in view of the above, and it is therefore an object of the present invention to provide a user terminal and a radio communication method, whereby, even when a number of waveforms are switched around and used, it is possible to reduce the decline in communication throughput.

### Solution to Problem

In accordance with one aspect of the present disclosure, a user terminal has a receiving section that receives downlink control information, a transmission section that transmits an uplink signal based on the downlink control information, and a control section that changes interpretation of a specific field, included in the downlink control information, depending on whether the waveform to apply to the uplink signal has already been indicated or not.

### Advantageous Effects of Invention

According to the present disclosure, it is possible to reduce the decline in communication throughput even when a number of waveforms are switched around and used.

### BRIEF DESCRIPTION OF DRAWINGS

FIG. 1 is a diagram to show examples of codebooks that apply in common to multiple waveforms;

FIG. 2 is a diagram to show an example of judging a specific field according to one embodiment;

FIG. 3 is a diagram to show examples of associations between indices of fields that show combinations of waveforms, ranks and TPMIs, and the values of these;

FIG. 4 is a diagram to show an exemplary schematic structure of a radio communication system according to one embodiment;

FIG. 5 is a diagram to show an exemplary overall structure of a radio base station according to one embodiment;

FIG. 6 is a diagram to show an exemplary functional structure of a radio base station according to one embodiment;

FIG. 7 is a diagram to show an exemplary overall structure of a user terminal according to one embodiment;

FIG. 8 is a diagram to show an exemplary functional structure of a user terminal according to one embodiment; and

FIG. 9 is a diagram to show an exemplary hardware structure of a radio base station and a user terminal according to one embodiment.

### DESCRIPTION OF EMBODIMENTS

NR is planned to support waveforms that are based on two different communication schemes (which may also be referred to as “multiplexing schemes,” “modulation schemes,” “access schemes,” “waveform schemes,” etc.), at least for the uplink for use for eMBB (enhanced Mobile Broad Band). These two types of waveforms are, to be more specific, a waveform based on cyclic prefix OFDM (or “CP-OFDM (Cyclic Prefix Orthogonal Frequency Division Multiplexing)”), and a waveform based on DFT-spread OFDM (or “DFT-S-OFDM (Discrete Fourier Transform Spread Orthogonal Frequency Division Multiplexing)”).

Note that the CP-OFDM waveform may be referred to as a “multi-carrier communication scheme waveform” and the DFT-S-OFDM waveform may be referred to as a “single-carrier communication scheme waveform.” Also, waveforms may be characterized based on whether or not DFT precoding (spreading) is applied to the OFDM waveform. For example, CP-OFDM may be referred to as the “waveform (signal) to which DFT precoding is not applied,” and DFT-S-OFDM may be referred to as the “waveform (signal) to which DFT precoding is applied.”

NR is anticipated to switch between and use CP-OFDM and DFT-S-OFDM, and so the waveform might switch even while communication is in progress. For example, the network (such as a base station (also referred to as a “gNB”)) may indicate, to UE, which one of the CP-OFDM-based waveform and the DFT-S-OFDM-based waveform should be used (or command to switch the waveform). This indication may be sent to the UE by using higher layer signaling, physical layer signaling, (for example, downlink control information (DCI)) or a combination of these.

For higher layer signaling, for example, RRC (Radio Resource Control) signaling, MAC (Medium Access Control) signaling (for example, MAC control element (MAC CE (Control Element))), broadcast information (for example, MIB (Master Information Block), SIB (System Information Block), etc.) and the like may be used.

Note that the DCI to schedule UL transmission may be referred to as a “UL grant,” a “transmission grant,” and so forth, and the DCI to schedule DL receipt may be referred to as a “DL assignment,” a “receipt grant,” and so forth.

Research is underway to use the CP-OFDM waveform and the DFT-S-OFDM waveform for single-stream transmission and multi-stream transmission. However, the DFT-S-OFDM waveform may be used only for single-stream transmission.

Note that single-stream transmission may be also referred to as “single-layer transmission,” “transmission where the number of layers is one,” “transmission of rank=1,” and so on. Multi-stream transmission may be referred to as “multi-layer transmission,” “transmission where the number of layers is n (n>1),” “transmission of rank=n (n>1),” “MIMO (Multi-Input Multi-Output) transmission,” and so on.

Now, in LTE, a codebook refers to a pre-determined candidate for a precoding matrix (or a table to show candidates). For example, a base station may select, based on a signal transmitted from UE, a precoding matrix that will increases throughput, from a codebook, and transmit information about a transmitted precoding matrix indicator (TPMI), as feedback. After that, the UE may apply precoding to signals to transmit to the base station, based on the received TPMI. Codebook-based precoding may also be applied to signals to be transmitted from the base station as well.

In NR, for example, configurations to use a common codebook for multiple waveforms or to use different codebooks (different types of codebooks) per waveform are under discussion for the uplink.

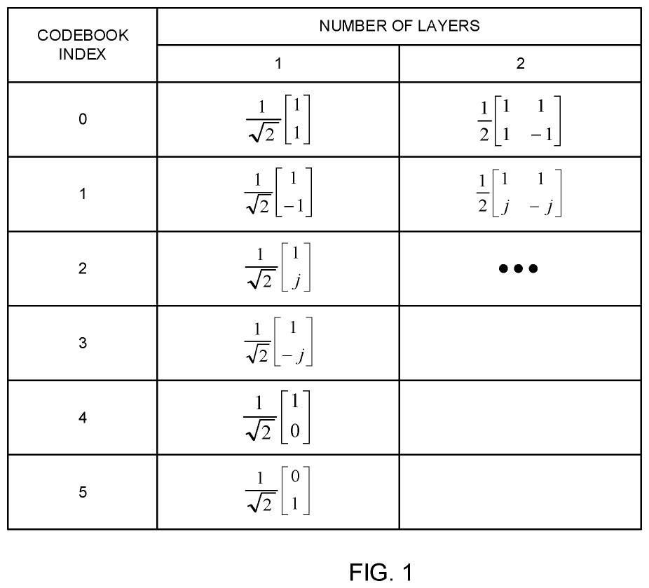

FIG. 1 is a diagram to show examples of codebooks that apply in common to multiple waveforms. In this example, a codebook index may be referred to as a “TPMI index.” For example, with this codebook, it may be assumed that DFT-S-OFDM may correspond to the precoders where the number of layers is one and the codebook indices=0 to 5 are assigned, and CP-OFDM may correspond at least to the precoders where the number of layers is one and the codebook indices=0 to 3 are assigned, and the precoders where the number of layers is two and the codebook indices=0 to 1 are assigned.

Therefore, a field to indicate the waveform may be introduced in a UL grant. However, if a field to indicate the waveform is contained in UL grants at all times, there is a problem that the amount of communication related to signaling will increase, and the throughput of communication will deteriorate. Existing LTE has assumed that a transmitter transmits only one type of waveform (UE transmits the DFT-S-OFDM waveform), and so this problem did not exist.

So the present inventors came up with a method for reducing the increase in the amount of DCI information even when a number of waveforms are used for transmission (or receipt).

Now, an embodiment of this disclosure will be described below in detail with reference to the accompanying drawings. The radio communication methods according to the herein-contained embodiment may be applied individually or may be applied in combinations.

(Radio Communication Method)

According to one embodiment of the present disclosure, UE judges which parameter corresponds to a specific field in DCI, based on predetermined conditions. Note that, although a case will be described below in which this DCI is a UL grant and the waveform is applied to the UL signal scheduled by the UL grant, this is by no means limiting. For example, this DCI may be a DL assignment. The waveform may be applied to the DL signal that is scheduled by the DL assignment. In the following description, “UL” may be replaced with “DL.”

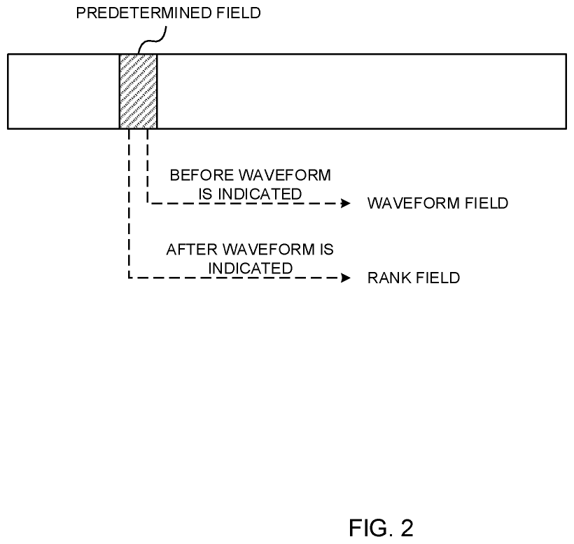

The predetermined condition may be whether a certain parameter is already configured (indicated or reported) in the UE or not. FIG. 2 is a diagram to show an example of judging a specific field according to one embodiment.

For example, as shown in FIG. 2, before the waveform is indicated to the UE (during initial access, etc.), the UE may interpret (assume) that a specific field, provided in received DCI, is used to indicate the waveform (is a waveform field to show waveform information).

Also, after the waveform is indicated to the UE (after RRC connection is established, during data communication, etc.), the UE may interpret that the specific field in the received DCI is used to indicate the rank (or the number of layers) (that is, the specific field is a rank field to show rank information).

If the specific field in DCI is not used to indicate the waveform, the UE may select the waveform to use for UL transmission without regard to this DCI. For example, the UE may select the waveform based on at least one of (1) to (5) below (that is, the waveform may be indicated by at least one of these):

(1) The specification;

(2) Higher layer signaling (RRC signaling, MAC signaling, SIB and so on, or a combination of these);

(3) Whether resources allocated for use for UL transmission are contiguous or non-contiguous;

(4) The waveform indicated during random access procedures (for example, the waveform indicated by the UL grant included in message 2 (random access response (RAR))); and

(5) A combination of (1) to (4) above.

Note that, even after the waveform is once indicated to the UE, if the state in which no waveform is indicated to the UE resumes, the UE may interpret that the waveform will be indicated using the above-described specific field. For example, in cases (A) to (C) below, the UE may assume that the state in which no waveform is indicated is resumed and/or that the waveform is to be reset:

(A) A signal to command a reset of the waveform is reported;

(B) Radio quality (received power (RSRP (Reference Signal Received Power)), received quality (RSRQ (Reference Signal Received Quality)), etc.) falls below a predetermined threshold; and

(C) A radio link failure (RLF) is detected.

Note that the signal to command resetting of the waveform may be transmitted by using higher layer signaling (for example, RRC signaling, MAC signaling, etc.), physical layer signaling (for example, DCI), or a combination of these.

The above specific field is preferably represented by one bit. If the specific field is used to indicate the waveform, for example, the first waveform or a second waveform may be indicated by a 1-bit value.

If the specific field is used to indicate the rank, for example, the first rank or the second rank may be indicated by a 1-bit value. The first rank and the second rank, or {first rank, second rank}, may be, for example, {1, 2}, {1, 3}, {1, 4}, {2, 3} and so forth, but these are by no means limiting.

If the specific field is used to indicate the rank, for example, the first rank group or the second rank group may be indicated by a 1-bit value. Here, a rank group refers to a group to include one or more ranks. The first rank group and the second rank group, or {first rank group, second rank group} are, for example, {{1, 2}, {3, 4}}, {{1}, {4}}, {{1, 2}, {4}} and so forth. In this way, the number of elements in each rank group may be the same or may vary. Note that these configurations of rank groups are by no means limiting.

If a rank group comprised of two or more ranks is indicated by a specific field, one of the ranks included in this rank group may be further indicated by another field included in the DCI.

For example, if the rank group {1, 2} is indicated, the UE may determine whether to look up the codebook of rank 1 or look up the codebook of rank 2 based on a field pertaining to precoding information (TPMI field, for example) included in the DCI.

The association between the above specific field and the parameters corresponding to this field (for example, the waveform, the rank, the rank group, etc.) may be reported to the UE by higher layer signaling (for example, RRC signaling, MAC signaling, SIB, etc.), physical layer signaling (for example, DCI), or a combination of these.

According to the embodiment described above, the same DCI format for UL grants can be used without regard to transmission parameters such as the waveform, the rank and so forth, so that the increase in the amount of DCI information can be reduced. In addition, compared to the case where a DCI format to include a waveform field and a DCI format to include no waveform field are defined both, the increase of the load on the UE associated with the PDCCH demodulation process can be reduced.

(Variations)

Although an example has been shown with the above embodiment where the specific field corresponds to the waveform or the rank (rank group), this is by no means limiting. For example, this “rank” may be replaced by a “codebook,” a “panel,” a “port,” and the like. Furthermore, the “waveform” may be replaced by other parameters. When there are parameters such as the waveform, the rank, the codebook, the panel and so forth, the UE may assume that the specific field shows information regarding at least one of the parameters that has not been indicated yet.

For example, after the waveform is indicated to the UE, the UE may interpret that the specific field in DCI that is received is used to indicate the codebook. When the DCI carries information regarding the number of panels for use for transmission, the UE can switch between and use different codebooks, depending on whether one or more panels are used for transmission.

When the DCI carries information regarding the type of precoding to use for transmission, the UE can switch between and use different codebooks depending on whether the precoding to use for transmission is wideband precoding or subband precoding.

If the DCI carries information regarding the stages of a dual-stage codebook, the UE can switch between and use the first stage and the second stage of the codebook for transmission, and use these stages for control.

In addition, after the waveform is indicated to the UE, the UE may interpret that the specific field in DCI that is received is used to indicate the panel. Note that the panel to be indicated may correspond to a resource indicator of a predetermined reference signal (for example, an SRS resource index (SRI)).

Furthermore, a field to show a combination of precoding information (for example, TPMI), a rank (the number of layers), and a waveform may be used instead of the specific field described above. That is, a bit sequence in which these are combined and joint-encoded may be reported in this field.

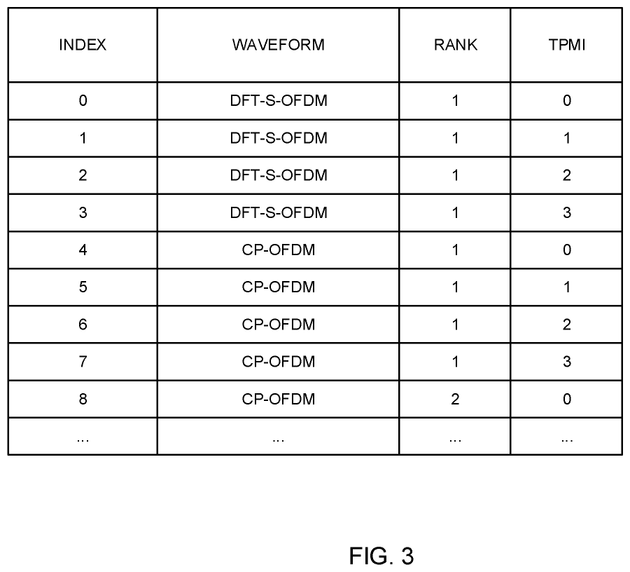

FIG. 3 is a diagram to show examples of associations between indices of fields that show combinations of waveforms, ranks and TPMIs, and the values of these. CP-OFDM and DFT-S-OFDM are shown as waveforms, 1 and 2 are shown as ranks, and 0 to 3 are shown as TPMIs, but these are by no means limiting. By representing multiple types of elements using one index, these elements can be handled in a flexible manner.

Note that the waveform needs not be indicated by the method described herein. The UE may select the waveform to use based on, for example, whether the number of ports/the number of layers to use for transmission and/or receipt is greater than a predetermined threshold or not, whether the scheduled resource is a wideband or not, and so forth.

(Radio Communication System)

Now, the structure of a radio communication system according to one embodiment will be described below. In this radio communication system, communication is performed using one of the radio communication methods according to the herein-contained embodiments, or a combination of these.

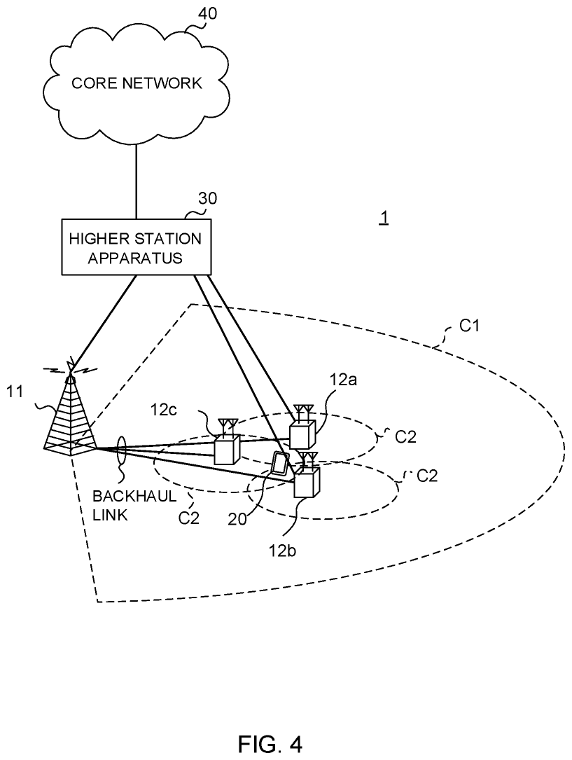

FIG. 4 is a diagram to show an exemplary schematic structure of a radio communication system according to one embodiment. A radio communication system 1 can adopt carrier aggregation (CA) and/or dual connectivity (DC) to group a plurality of fundamental frequency blocks (component carriers) into one, where the LTE system bandwidth (for example, 20 MHz) constitutes one unit.

Note that the radio communication system 1 may be referred to as “LTE (Long Term Evolution),” “LTE-A (LTE-Advanced),” “LTE-B (LTE-Beyond),” “SUPER 3G,” “IMT-Advanced,” “4G (4th generation mobile communication system),” “5G (5th generation mobile communication system),” “NR (New Radio),” “FRA (Future Radio Access),” “New-RAT (Radio Access Technology),” and so on, or may be seen as a system to implement these.

The radio communication system 1 includes a radio base station 11 that forms a macro cell C1, with a relatively wide coverage, and radio base stations 12 (12a to 12c) that are placed within the macro cell C1 and that form small cells C2, which are narrower than the macro cell C1. Also, user terminals 20 are placed in the macro cell C1 and in each small cell C2. The arrangement and number of cells and user terminals 20 and so forth are not limited to those illustrated in the drawings.

The user terminals 20 can connect with both the radio base station 11 and the radio base stations 12. The user terminals 20 may use the macro cell C1 and the small cells C2 at the same time by means of CA or DC. Furthermore, the user terminals 20 may apply CA or DC using a plurality of cells (CCs) (for example, five or fewer CCs or six or more CCs).

Between the user terminals 20 and the radio base station 11, communication can be carried out using a carrier of a relatively low frequency band (for example, 2 GHz) and a narrow bandwidth (referred to as, for example, an “existing carrier,” a “legacy carrier” and so on). Meanwhile, between the user terminals 20 and the radio base stations 12, a carrier of a relatively high frequency band (for example, 3.5 GHz, 5 GHz and so on) and a wide bandwidth may be used, or the same carrier as that used in the radio base station 11 may be used. Note that the structure of the frequency band for use in each radio base station is by no means limited to these.

Furthermore, the user terminals 20 can communicate by using time division duplexing (TDD) and/or frequency division duplexing (FDD), in each cell. Furthermore, in each cell (carrier), a single numerology may be used, or a plurality of different numerologies may be used.

A numerology may refer to a communication parameter that is applied to transmission and/or receipt of a given signal and/or channel, and represent at least one of the subcarrier spacing (SCS), the bandwidth, the duration of symbols, the length of cyclic prefixes, the duration of subframes, the length of TTIs (Transmission Time Intervals) (for example, the length of slots), the number of symbols per TTI, the radio frame configuration, the filtering process, the windowing process, and so on.

The radio base station 11 and a radio base station 12 (or two radio base stations 12) may be connected with each other by cables (for example, by optical fiber, which is in compliance with the CPRI (Common Public Radio Interface), the X2 interface and so on), or by radio.

The radio base station 11 and the radio base stations 12 are each connected with higher station apparatus 30, and are connected with a core network 40 via the higher station apparatus 30. Note that the higher station apparatus 30 may be, for example, access gateway apparatus, a radio network controller (RNC), a mobility management entity (MME) and so on, but these are by no means limiting. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNB (eNodeB),” a “transmitting/receiving point” and so on. Also, the radio base stations 12 are radio base stations each having a local coverage, and may be referred to as “small base stations,” “micro base stations,” “pico base stations,” “femto base stations,” “HeNBs (Home eNodeBs),” “RRHs (Remote Radio Heads),” “transmitting/receiving points” and so on. Hereinafter, the radio base stations 11 and 12 will be collectively referred to as “radio base stations 10,” unless specified otherwise.

The user terminals 20 are terminals that support various communication schemes such as LTE, LTE-A and so on, and may be either mobile communication terminals (mobile stations) or stationary communication terminals (fixed stations).

In the radio communication system 1, as radio access schemes, orthogonal frequency division multiple access (OFDMA) is applied to the downlink, and single-carrier frequency division multiple access (SC-FDMA) and/or OFDMA are applied to the uplink.

OFDMA is a multi-carrier communication scheme to perform communication by dividing a frequency bandwidth into a plurality of narrow frequency bandwidths (subcarriers) and mapping data to each subcarrier. SC-FDMA is a single-carrier communication scheme to mitigate interference between terminals by dividing the system bandwidth into bands that are each formed with one or contiguous resource blocks, per terminal, and allowing a plurality of terminals to use mutually different bands. Note that the uplink and downlink radio access schemes are not limited to the combinations of these, and other radio access schemes may be used as well.

In the radio communication system 1, a downlink shared channel (PDSCH (Physical Downlink Shared CHannel)), which is used by each user terminal 20 on a shared basis, a broadcast channel (PBCH (Physical Broadcast CHannel)), downlink L1/L2 control channels and so on are used as downlink channels. User data, higher layer control information, SIBs (System Information Blocks) and so on are communicated in the PDSCH. Also, the MIB (Master Information Blocks) is communicated in the PBCH.

The downlink L1/L2 control channels include a PDCCH (Physical Downlink Control CHannel), an EPDCCH (Enhanced Physical Downlink Control CHannel), a PCFICH (Physical Control Format Indicator CHannel), a PHICH (Physical Hybrid-ARQ Indicator CHannel) and so on. Downlink control information (DCI), which includes PDSCH and/or PUSCH scheduling information and so on, is communicated by the PDCCH.

Note that scheduling information may be reported in DCI. For example, the DCI to schedule receipt of DL data may be referred to as “DL assignment,” and the DCI to schedule transmission of UL data may also be referred to as “UL grant.”

The number of OFDM symbols to use for the PDCCH is communicated by the PCFICH. HARQ (Hybrid Automatic Repeat reQuest) delivery acknowledgment information (also referred to as, for example, “retransmission control information,” “HARQ-ACKs,” “ACKs/NACKs,” etc.) in response to the PUSCH is transmitted by the PHICH. The EPDCCH is frequency-division-multiplexed with the PDSCH (downlink shared data channel) and used to communicate DCI and so on, like the PDCCH.

In the radio communication system 1, an uplink shared channel (PUSCH (Physical Uplink Shared CHannel)), which is used by each user terminal 20 on a shared basis, an uplink control channel (PUCCH (Physical Uplink Control CHannel)), a random access channel (PRACH (Physical Random Access CHannel)) and so on are used as uplink channels. User data, higher layer control information and so on are communicated by the PUSCH. Also, in the PUCCH, downlink radio quality information (CQI (Channel Quality Indicator)), delivery acknowledgment information, scheduling requests (SRs) and so on are communicated. By means of the PRACH, random access preambles for establishing connections with cells are communicated.

In the radio communication system 1, cell-specific reference signals (CRSs), channel state information reference signals (CSI-RSs), demodulation reference signals (DMRSs), positioning reference signals (PRSs) and so on are communicated as downlink reference signals. Also, in the radio communication system 1, measurement reference signals (SRSs (Sounding Reference Signals)), demodulation reference signals (DMRSs) and so on are communicated as uplink reference signals. Note that the DMRSs may be referred to as “user terminal-specific reference signals (UE-specific reference signals).” Also, the reference signals to be communicated are by no means limited to these.

(Radio Base Station)

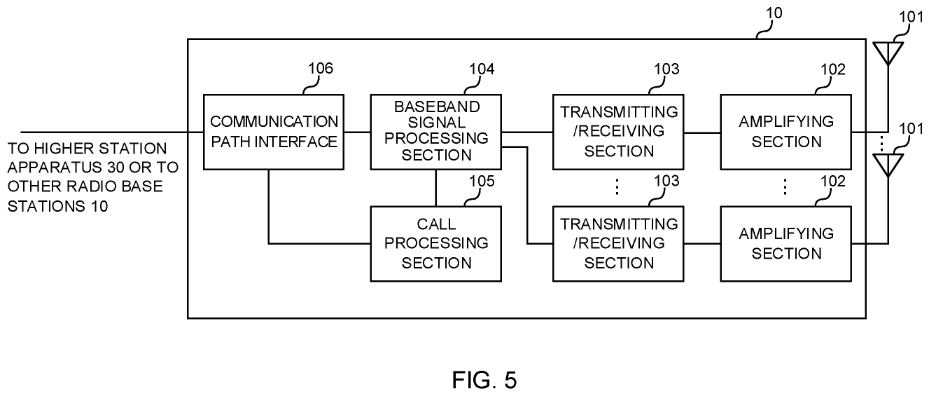

FIG. 5 is a diagram to show an exemplary overall structure of a radio base station according to one embodiment. A radio base station 10 has a plurality of transmitting/receiving antennas 101, amplifying sections 102, transmitting/receiving sections 103, a baseband signal processing section 104, a call processing section 105 and a communication path interface 106. Note that one or more transmitting/receiving antennas 101, amplifying sections 102 and transmitting/receiving sections 103 may be provided.

User data to be transmitted from the radio base station 10 to a user terminal 20 on the downlink is input from the higher station apparatus 30, to the baseband signal processing section 104, via the communication path interface 106.

In the baseband signal processing section 104, the user data is subjected to transmission processes, including a PDCP (Packet Data Convergence Protocol) layer process, user data division and coupling, RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Baseband signals that are precoded and output from the baseband signal processing section 104 on a per antenna basis are converted into a radio frequency band in the transmitting/receiving sections 103, and then transmitted. The radio frequency signals having been subjected to frequency conversion in the transmitting/receiving sections 103 are amplified in the amplifying sections 102, and transmitted from the transmitting/receiving antennas 101. The transmitting/receiving sections 103 can be constituted by transmitters/receivers, transmitting/receiving circuits or transmitting/receiving apparatus that can be described based on general understanding of the technical field to which the present disclosure pertains. Note that a transmitting/receiving section 103 may be structured as a transmitting/receiving section in one entity, or may be constituted by a transmitting section and a receiving section.

Meanwhile, as for uplink signals, radio frequency signals that are received in the transmitting/receiving antennas 101 are each amplified in the amplifying sections 102. The transmitting/receiving sections 103 receive the uplink signals amplified in the amplifying sections 102. The received signals are converted into the baseband signal through frequency conversion in the transmitting/receiving sections 103 and output to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing (such as setting up and releasing communication channels), manages the state of the radio base station 10, and manages the radio resources.

The communication path interface section 106 transmits and receives signals to and from the higher station apparatus 30 via a predetermined interface. Also, the communication path interface 106 may transmit and receive signals (backhaul signaling) with other radio base stations 10 via an inter-base station interface (which is, for example, optical fiber that is in compliance with the CPRI (Common Public Radio Interface), the X2 interface, etc.).

The transmitting/receiving sections 103 perform receiving processes for signals transmitted from the user terminal 20 or performs transmission processes for signals received at the user terminal 20, based on downlink control information (UL grant, DL assignment, etc.).

The transmitting/receiving sections 103 transmit downlink control information (DCI) to the user terminal 20. The transmitting/receiving sections 103 perform receiving processes for signals transmitted based on the DCI, or perform transmission processes for signals received based on the DCI. This DCI may include a specific field that is interpreted differently based on predetermined conditions.

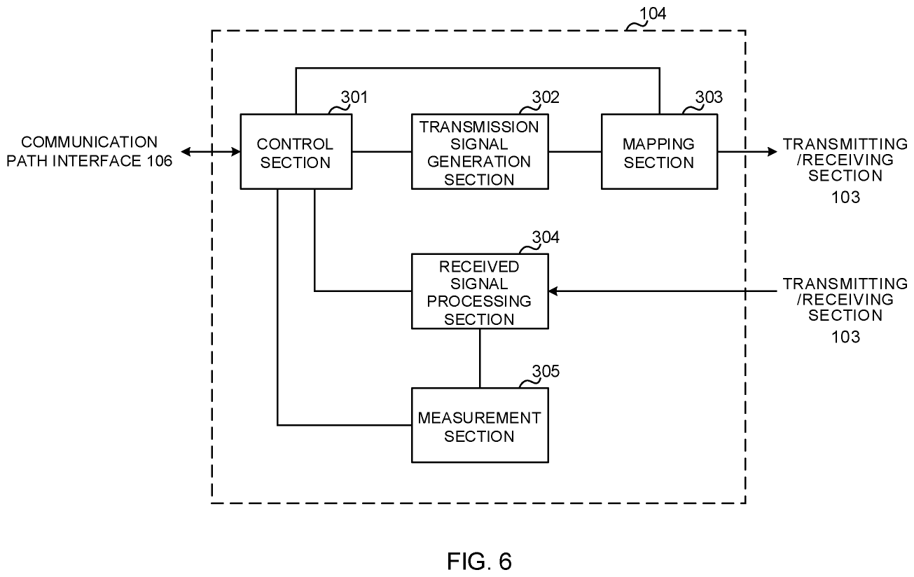

FIG. 6 is a diagram to show an exemplary functional structure of a radio base station according to one embodiment. Note that, although this example primarily shows functional blocks that pertain to characteristic parts of the present embodiment, the radio base station 10 has other functional blocks that are necessary for radio communication as well.

The baseband signal processing section 104 at least has a control section (scheduler) 301, a transmission signal generation section 302, a mapping section 303, a received signal processing section 304 and a measurement section 305. Note that these configurations have only to be included in the radio base station 10, and some or all of these configurations may not be included in the baseband signal processing section 104.

The control section (scheduler) 301 controls the whole of the radio base station 10. The control section 301 can be constituted by a controller, a control circuit or control apparatus that can be described based on general understanding of the technical field to which the present disclosure pertains.

The control section 301 controls, for example, generation of signals in the transmission signal generation section 302, allocation of signals in the mapping section 303, and so on. Furthermore, the control section 301 controls signal receiving processes in the received signal processing section 304, measurements of signals in the measurement section 305, and so on.

The control section 301 controls the scheduling (for example, resource allocation) of system information, downlink data signals (for example, signals transmitted in the PDSCH), and downlink control signals (for example, signals transmitted in the PDCCH and/or the EPDCCH, such as delivery acknowledgement information). Also, the control section 301 controls the generation of downlink control signals, downlink data signals and so on, based on results of deciding whether or not retransmission control is necessary for uplink data signals, and so on. Also, the control section 301 controls the scheduling of synchronization signals (for example, the PSS (Primary Synchronization Signal)/SSS (Secondary Synchronization Signal)), downlink reference signals (for example, the CRS, the CSI-RS, the DMRS, etc.) and so on.

Furthermore, the control section 301 controls the scheduling of uplink data signals (for example, signals transmitted in the PUSCH), uplink control signals (for example, signals transmitted in the PUCCH and/or the PUSCH, such as delivery acknowledgment information), random access preambles (for example, signals transmitted in the PRACH), uplink reference signals, and so forth.

The control section 301 may include a specific field that is interpreted differently based on predetermined conditions, in DCI, and transmit this.

For example, when the waveform to apply to an uplink signal has already been indicated to the user terminal 20, the control section 301 may include a field to show information about the rank, as a specific field, in DCI, and, otherwise, include a field to show information about the waveform, as a specific field, in DCI.

The transmission signal generation section 302 generates downlink signals (downlink control signals, downlink data signals, downlink reference signals, and so on) based on commands from the control section 301, and outputs these signals to the mapping section 303. The transmission signal generation section 302 can be constituted by a signal generator, a signal generating circuit or signal generating apparatus that can be described based on general understanding of the technical field to which the present disclosure pertains.

For example, the transmission signal generation section 302 generates DL assignments, which report downlink data allocation information, and/or UL grants, which report uplink data allocation information, based on commands from the control section 301. DL assignments and UL grants are both DCI, in compliance with DCI format. Also, the downlink data signals are subjected to the coding process and the modulation process by using coding rates, modulation schemes and so on that are determined based on, for example, channel state information (CSI) from each user terminal 20.

The mapping section 303 maps the downlink signals generated in the transmission signal generation section 302 to predetermined radio resources based on commands from the control section 301, and outputs these to the transmitting/receiving sections 103. The mapping section 303 can be constituted by a mapper, a mapping circuit or mapping apparatus that can be described based on general understanding of the technical field to which the present disclosure pertains.

The received signal processing section 304 performs receiving processes (for example, demapping, demodulation, decoding and so on) of received signals that are input from the transmitting/receiving sections 103. Here, the received signals include, for example, uplink signals transmitted from the user terminal 20 (uplink control signals, uplink data signals, uplink reference signals, etc.). The received signal processing section 304 can be constituted by a signal processor, a signal processing circuit or signal processing apparatus that can be described based on general understanding of the technical field to which the present disclosure pertains.

The received signal processing section 304 outputs the decoded information acquired through the receiving processes, to the control section 301. For example, when a PUCCH to contain an HARQ-ACK is received, the received signal processing section 304 outputs this HARQ-ACK to the control section 301. Also, the received signal processing section 304 outputs the received signals and/or the signals after the receiving processes to the measurement section 305.

The measurement section 305 conducts measurements with respect to the received signals. The measurement section 305 can be constituted by a measurer, a measurement circuit or measurement apparatus that can be described based on general understanding of the technical field to which the present disclosure pertains.

For example, the measurement section 305 may perform RRM (Radio Resource Management) measurements, CSI (Channel State Information) measurements, and so on, based on the received signals. The measurement section 305 may measure the received power (for example, RSRP (Reference Signal Received Power)), the received quality (for example, RSRQ (Reference Signal Received Quality), SINR (Signal to Interference plus Noise Ratio), SNR (Signal to Noise Ratio), etc.), the signal strength (for example, RSSI (Received Signal Strength Indicator)), transmission path information (for example, CSI) and so on. The measurement results may be output to the control section 301.

(User Terminal)

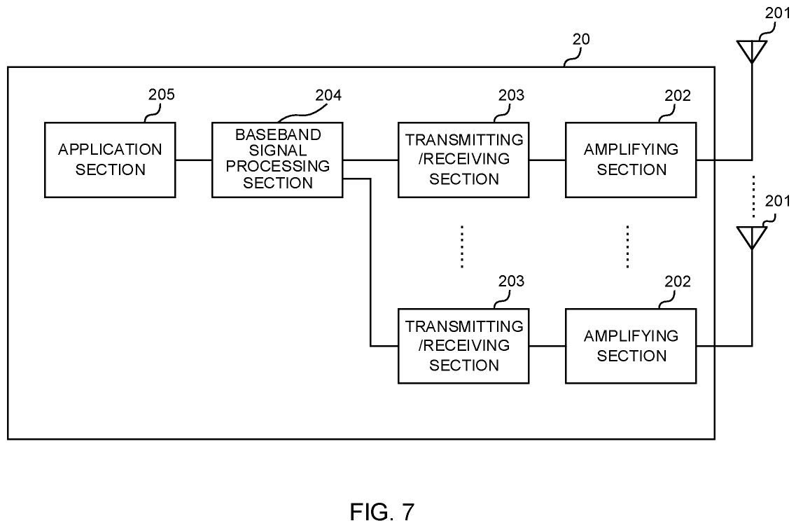

FIG. 7 is a diagram to show an exemplary overall structure of a user terminal according to one embodiment. A user terminal 20 has a plurality of transmitting/receiving antennas 201, amplifying sections 202, transmitting/receiving sections 203, a baseband signal processing section 204, and an application section 205. Note that one or more transmitting/receiving antennas 201, amplifying sections 202 and transmitting/receiving sections 203 may be provided.

Radio frequency signals that are received in the transmitting/receiving antennas 201 are amplified in the amplifying sections 202. The transmitting/receiving sections 203 receive the downlink signals amplified in the amplifying sections 202. The received signals are subjected to frequency conversion and converted into the baseband signal in the transmitting/receiving sections 203, and output to the baseband signal processing section 204. A transmitting/receiving section 203 can be constituted by a transmitters/receiver, a transmitting/receiving circuit or transmitting/receiving apparatus that can be described based on general understanding of the technical field to which the present disclosure pertains. Note that a transmitting/receiving section 203 may be structured as a transmitting/receiving section in one entity, or may be constituted by a transmitting section and a receiving section.

The baseband signal processing section 204 performs, for the baseband signal that is input, an FFT process, error correction decoding, a retransmission control receiving process, and so on. Downlink user data is forwarded to the application section 205. The application section 205 performs processes related to higher layers above the physical layer and the MAC layer, and so on. Also, in the downlink data, the broadcast information can be also forwarded to the application section 205.

Meanwhile, uplink user data is input from the application section 205 to the baseband signal processing section 204. The baseband signal processing section 204 performs a retransmission control transmission process (for example, an HARQ transmission process), channel coding, precoding, a discrete Fourier transform (DFT) process, an IFFT process and so on, and the result is forwarded to the transmitting/receiving sections 203. Baseband signals that are output from the baseband signal processing section 204 are converted into a radio frequency band in the transmitting/receiving sections 203, and transmitted. The radio frequency signals that are subjected to frequency conversion in the transmitting/receiving sections 203 are amplified in the amplifying sections 202, and transmitted from the transmitting/receiving antennas 201.

The transmitting/receiving sections 203 receive downlink control information (DCI), and perform signal transmission processes or receiving processes based on the downlink control information. This DCI may include specific field that is interpreted differently based on predetermined conditions.

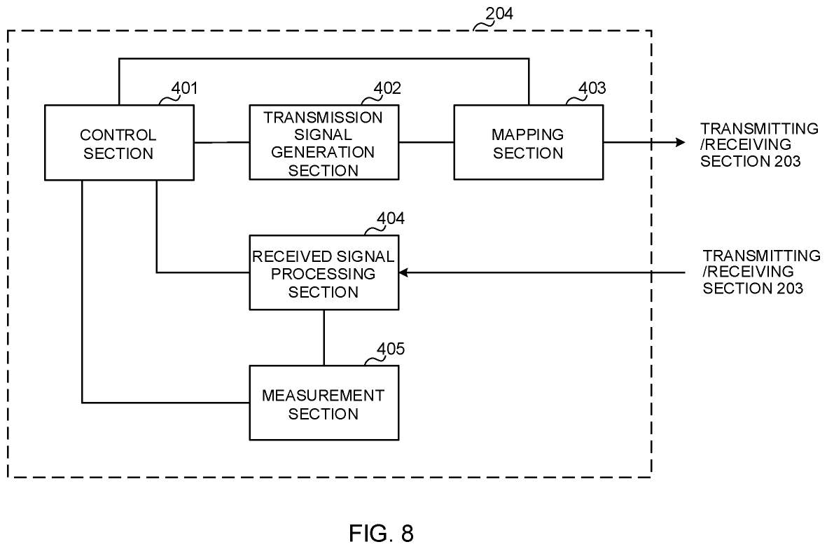

FIG. 8 is a diagram to show an exemplary functional structure of a user terminal according to one embodiment. Note that, although this example primarily shows functional blocks that pertain to characteristic parts of the present embodiment, the user terminal 20 has other functional blocks that are necessary for radio communication as well.

The baseband signal processing section 204 provided in the user terminal 20 at least has a control section 401, a transmission signal generation section 402, a mapping section 403, a received signal processing section 404, and a measurement section 405. Note that these configurations have only to be included in the user terminal 20, and some or all of these configurations may not be included in the baseband signal processing section 204.

The control section 401 controls the whole of the user terminal 20. The control section 401 can be constituted by a controller, a control circuit or control apparatus that can be described based on general understanding of the technical field to which the present disclosure pertains.

The control section 401 controls, for example, generation of signals in the transmission signal generation section 402, allocation of signals in the mapping section 403, and so on. Furthermore, the control section 401 controls signal receiving processes in the received signal processing section 404, measurements of signals in the measurement section 405, and so on.

The control section 401 acquires the downlink control signals and downlink data signals transmitted from the radio base station 10, via the received signal processing section 404. The control section 401 controls the generation of uplink control signals and/or uplink data signals based on results of deciding whether or not retransmission control is necessary for the downlink control signals and/or downlink data signals, and so on.

The control section 401 may change the interpretation of a specific field, included in DCI acquired from the received signal processing section 404, based on predetermined conditions.

For example, if the waveform to apply to an uplink signal has already been indicated (determined), the control section 401 may interpret that the specific field shows information about the rank, and, otherwise, interpret that the specific field shows information about the waveform.

If the waveform to apply to an uplink signal has already been indicated, the control section 401 may interpret that the specific field shows a rank group comprised of one or more ranks. In this case, the control section 401 may exert control so that, based on another field included in the DCI, one of the ranks in the above rank group is used to transmit the uplink signal. Also, the control section 401 may exert control so that, based on another piece of information (for example, information reported through RRC signaling, MAC signaling, etc.), one of the ranks in the rank group is used to transmit the uplink signal.

The above rank group may accommodate different numbers of ranks, depending on the value of the specific field.

If the waveform to apply to an uplink signal is indicated, and the waveform is reset later (for example, a signal to command resetting of the waveform is reported), the control section 401 may interpret that the specific field shows information about the waveform.

In addition, when various pieces of information reported from the radio base station 10 are acquired from the received signal processing section 404, the control section 401 may update the parameters used for control based on the information.

The transmission signal generation section 402 generates uplink signals (uplink control signals, uplink data signals, uplink reference signals, etc.) based on commands from the control section 401, and outputs these signals to the mapping section 403. The transmission signal generation section 402 can be constituted by a signal generator, a signal generating circuit, or signal generation apparatus that can be described based on general understanding of the technical field to which the present disclosure pertains.

For example, the transmission signal generation section 402 generates uplink control signals such as delivery acknowledgement information, channel state information (CSI) and so on, based on commands from the control section 401. Also, the transmission signal generation section 402 generates uplink data signals based on commands from the control section 401. For example, when a UL grant is included in a downlink control signal that is reported from the radio base station 10, the control section 401 commands the transmission signal generation section 402 to generate an uplink data signal.

The mapping section 403 maps the uplink signals generated in the transmission signal generation section 402 to radio resources based on commands from the control section 401, and outputs these to the transmitting/receiving sections 203. The mapping section 403 can be constituted by a mapper, a mapping circuit or mapping apparatus that can be described based on general understanding of the technical field to which the present disclosure pertains.

The received signal processing section 404 performs receiving processes (for example, demapping, demodulation, decoding and so on) for received signals that are input from the transmitting/receiving sections 203. Here, the received signals include, for example, downlink signals (downlink control signals, downlink data signals, downlink reference signals, and so on) that are transmitted from the radio base station 10. The received signal processing section 404 can be constituted by a signal processor, a signal processing circuit or signal processing apparatus that can be described based on general understanding of the technical field to which the present disclosure pertains. Also, the received signal processing section 404 can constitute the receiving section according to the present disclosure.

The received signal processing section 404 outputs the decoded information acquired through the receiving processes, to the control section 401. The received signal processing section 404 outputs, for example, broadcast information, system information, RRC signaling, DCI and so on, to the control section 401. Also, the received signal processing section 404 outputs the received signals and/or the signals after the receiving processes to the measurement section 405.

The measurement section 405 conducts measurements with respect to the received signals. The measurement section 405 can be constituted by a measurer, a measurement circuit or measurement apparatus that can be described based on general understanding of the technical field to which the present disclosure pertains.

For example, the measurement section 405 may perform RRM measurements, CSI measurements, and so on, based on the received signals. The measurement section 405 may measure the received power (for example, RSRP), the received quality (for example, RSRQ, SINR, SNR, etc.), the signal strength (for example, RSSI), transmission path information (for example, CSI), and so on. The measurement results may be output to the control section 401.

(Hardware Structure)

Note that the block diagrams that have been used to describe the above embodiments show blocks in functional units. These functional blocks (components) may be implemented in arbitrary combinations of hardware and/or software. Also, the method for implementing each functional block is not particularly limited. That is, each functional block may be realized by one piece of apparatus that is physically and/or logically aggregated, or may be realized by directly and/or indirectly connecting two or more physically and/or logically-separate pieces of apparatus (by using cables and/or radio, for example) and using these multiple pieces of apparatus.

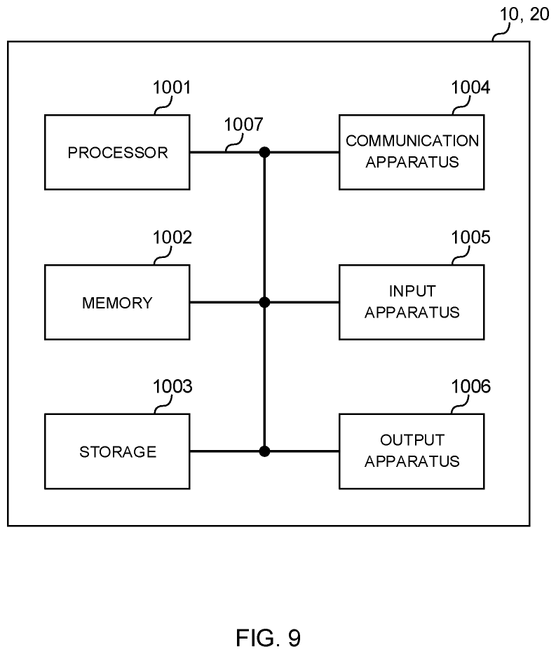

For example, the radio base station, user terminals and so on according to one embodiment of this disclosure of the present invention may function as a computer that executes the processes of the radio communication method of the present invention. FIG. 9 is a diagram to show an example hardware structure of a radio base station and a user terminal according to one embodiment. Physically, the above-described radio base stations 10 and user terminals 20 may be formed as a computer apparatus that includes a processor 1001, a memory 1002, a storage 1003, communication apparatus 1004, input apparatus 1005, output apparatus 1006, a bus 1007 and so on.

Note that, in the following description, the term “apparatus” may be replaced by “circuit,” “device,” “unit” and so on. Note that, the hardware structure of a radio base station 10 and a user terminal 20 may be designed to include one or more of each apparatus shown in the drawings, or may be designed not to include part of the apparatus.

For example, although only one processor 1001 is shown, a plurality of processors may be provided. Furthermore, processes may be implemented with one processor, or processes may be implemented simultaneously or in sequence, or by using different techniques, on one or more processors. Note that the processor 1001 may be implemented with one or more chips.

The functions of the radio base station 10 and the user terminal 20 are implemented by, for example, allowing hardware such as the processor 1001 and the memory 1002 to read predetermined software (programs), and allowing the processor 1001 to do calculations, control communication that involves the communication apparatus 1004, control the reading and/or writing of data in the memory 1002 and the storage 1003, and so on.

The processor 1001 may control the whole computer by, for example, running an operating system. The processor 1001 may be configured with a central processing unit (CPU), which includes interfaces with peripheral apparatus, control apparatus, computing apparatus, a register and so on. For example, the above-described baseband signal processing section 104 (204), call processing section 105, and so on may be implemented by the processor 1001.

Furthermore, the processor 1001 reads programs (program codes), software modules, data, and so forth from the storage 1003 and/or the communication apparatus 1004, into the memory 1002, and executes various processes according to these. As for the programs, programs to allow computers to execute at least part of the operations of the above-described embodiments may be used. For example, the control section 401 of the user terminals 20 may be implemented by control programs that are stored in the memory 1002 and that operate on the processor 1001, and other functional blocks may be implemented likewise.

The memory 1002 is a computer-readable recording medium, and may be constituted by, for example, at least one of a ROM (Read Only Memory), an EPROM (Erasable Programmable ROM), an EEPROM (Electrically EPROM), a RAM (Random Access Memory) and/or other appropriate storage media. The memory 1002 may be referred to as a “register,” a “cache,” a “main memory (primary storage apparatus),” and so on. The memory 1002 can store executable programs (program codes), software modules and so on for implementing the radio communication methods according to embodiments of the present invention.

The storage 1003 is a computer-readable recording medium, and may be constituted by, for example, at least one of a flexible disk, a floppy (registered trademark) disk, a magneto-optical disk (for example, a compact disc (CD-ROM (Compact Disc ROM) and so on), a digital versatile disc, a Blu-ray (registered trademark) disk), a removable disk, a hard disk drive, a smart card, a flash memory device (for example, a card, a stick, a key drive, etc.), a magnetic stripe, a database, a server, and/or other appropriate storage media. The storage 1003 may be referred to as “secondary storage apparatus.”

The communication apparatus 1004 is hardware (transmitting/receiving device) for allowing inter-computer communication by using cable and/or wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer and so on in order to realize, for example, frequency division duplex (FDD) and/or time division duplex (TDD). For example, the above-described transmitting/receiving antennas 101 (201), amplifying sections 102 (202), transmitting/receiving sections 103 (203), communication path interface 106 and so on may be implemented by the communication apparatus 1004.

The input apparatus 1005 is an input device for receiving input from outside (for example, a keyboard, a mouse, a microphone, a switch, a button, a sensor and so on). The output apparatus 1006 is an output device for allowing sending output to the outside (for example, a display, a speaker, an LED (Light Emitting Diode) lamp and so on). Note that the input apparatus 1005 and the output apparatus 1006 may be provided in an integrated structure (for example, a touch panel).

Furthermore, these pieces of apparatus, including the processor 1001, the memory 1002 and so on, are connected by the bus 1007, so as to communicate information. The bus 1007 may be formed with a single bus, or may be formed with buses that vary between pieces of apparatus.

Also, the radio base station 10 and the user terminal 20 may be structured to include hardware such as a microprocessor, a digital signal processor (DSP), an ASIC (Application-Specific Integrated Circuit), a PLD (Programmable Logic Device), an FPGA (Field Programmable Gate Array) and so on, and part or all of the functional blocks may be implemented by the hardware. For example, the processor 1001 may be implemented with at least one of these pieces of hardware.

(Variations)

Note that, the terminology used in this specification and the terminology that is needed to understand this specification may be replaced by other terms that communicate the same or similar meanings. For example, a “channel” and/or a “symbol” may be replaced by a “signal” (or “signaling”). Also, a “signal” may be a “message.” A reference signal may be abbreviated as an “RS,” and may be referred to as a “pilot,” a “pilot signal” and so on, depending on which standard applies. Furthermore, a “component carrier (CC)” may be referred to as a “cell,” a “frequency carrier,” a “carrier frequency” and so on.

Furthermore, a radio frame may be comprised of one or more periods (frames) in the time domain. One or more periods (frames) that constitute a radio frame may be each referred to as a “subframe.” Furthermore, a subframe may be comprised of one or multiple slots in the time domain. A subframe may be a fixed time duration (for example, 1 ms), which does not depend on numerology.

Furthermore, a slot may be comprised of one or more symbols in the time domain (OFDM (Orthogonal Frequency Division Multiplexing) symbols, SC-FDMA (Single Carrier Frequency Division Multiple Access) symbols, and so on). Also, a slot may be a time unit based on numerology. Also, a slot may include a plurality of mini-slots. Each mini-slot may be comprised of one or more symbols in the time domain. Also, a mini-slot may be referred to as a “subslot.”

A radio frame, a subframe, a slot, a mini-slot, and a symbol all refer to a unit of time in signal communication. A radio frame, a subframe, a slot, a mini-slot and a symbol may be each called by other applicable names. For example, one subframe may be referred to as a “transmission time interval (TTI),” or a plurality of consecutive subframes may be referred to as a “TTI,” or one slot or one mini-slot may be referred to as a “TTI.” That is, a subframe and/or a TTI may be a subframe (1 ms) in existing LTE, may be a shorter period than 1 ms (for example, one to thirteen symbols), or may be a longer period of time than 1 ms. Note that the unit to represent a TTI may be referred to as a “slot,” a “mini-slot” and so on, instead of a “subframe.”

Here, a TTI refers to the minimum time unit for scheduling in radio communication, for example. For example, in LTE systems, a radio base station schedules the radio resources (such as the frequency bandwidth and transmission power each user terminal can use) to allocate to each user terminal in TTI units. Note that the definition of TTIs is not limited to this.

A TTI may be the transmission time unit of channel-encoded data packets (transport blocks), code blocks and/or codewords, or may be the unit of processing in scheduling, link adaptation, and so on. Note that, when a TTI is given, the period of time (for example, the number of symbols) in which transport blocks, code blocks and/or codewords are actually mapped may be shorter than the TTI.

Note that, when one slot or one mini-slot is referred to as a “TTI,” one or more TTIs (that is, one or multiple slots or one or more mini-slots) may be the minimum time unit of scheduling. Also, the number of slots (the number of mini-slots) to constitute this minimum time unit for scheduling may be controlled.

A TTI having a time duration of 1 ms may be referred to as a “normal TTI” (TTI in LTE Rel. 8 to 12), a “long TTI,” a “normal subframe,” a “long subframe,” and so on. A TTI that is shorter than a normal TTI may be referred to as a “shortened TTI,” a “short TTI,” a “partial TTI” (or a “fractional TTI”), a “shortened subframe,” a “short subframe,” a “mini-slot,” a “sub-slot” and so on.

Note that a long TTI (for example, a normal TTI, a subframe, etc.) may be replaced with a TTI having a time duration exceeding 1 ms, and a short TTI (for example, a shortened TTI) may be replaced with a TTI having a TTI length less than the TTI length of a long TTI and not less than 1 ms.

A resource block (RB) is the unit of resource allocation in the time domain and the frequency domain, and may include one or a plurality of consecutive subcarriers in the frequency domain. Also, an RB may include one or more symbols in the time domain, and may be one slot, one mini-slot, one subframe or one TTI in length. One TTI and one subframe each may be comprised of one or more resource blocks. Note that one or more RBs may be referred to as a “physical resource block (PRB (Physical RB)),” a “subcarrier group (SCG),” a “resource element group (REG),” a “PRB pair,” an “RB pair” and so on.

Furthermore, a resource block may be comprised of one or more resource elements (REs). For example, one RE may be a radio resource field of one subcarrier and one symbol.

Note that the structures of radio frames, subframes, slots, mini-slots, symbols, and so on described above are simply examples. For example, configurations pertaining to the number of subframes included in a radio frame, the number of slots included per subframe or radio frame, the number of mini-slots included in a slot, the number of symbols and RBs included in a slot or a mini-slot, the number of subcarriers included in an RB, the number of symbols in a TTI, the symbol duration, the length of cyclic prefixes (CPs) and so on can be variously changed.

Also, the information and parameters described in this specification may be represented in absolute values or in relative values with respect to predetermined values, or may be represented using other applicable information. For example, a radio resource may be specified by a predetermined index.

The names used for parameters and so on in this specification are in no respect limiting. For example, since various channels (PUCCH (Physical Uplink Control CHannel), PDCCH (Physical Downlink Control CHannel) and so on) and information elements can be identified by any suitable names, ※ the various names assigned to these individual channels and information elements are in no respect limiting.

The information, signals and/or others described in this specification may be represented by using a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Also, information, signals, and so on can be output from higher layers to lower layers, and/or from lower layers to higher layers. Information, signals, and so on may be input and/or output via a plurality of network nodes.

The information, signals, and so on that are input and/or output may be stored in a specific location (for example, in a memory), or may be managed in a control table. The information, signals, and so on to be input and/or output can be overwritten, updated, or appended. The information, signals, and so on that are output may be deleted. The information, signals, and so on that are input may be transmitted to other pieces of apparatus.

Reporting of information is by no means limited to the examples/embodiments described in this specification, and other methods may be used as well. For example, reporting of information may be implemented by using physical layer signaling (for example, downlink control information (DCI), uplink control information (UCI)), higher layer signaling (for example, RRC (Radio Resource Control) signaling, broadcast information (the master information block (MIB), system information blocks (SIBs) and so on), MAC (Medium Access Control) signaling and so on), and other signals and/or combinations of these.

Note that physical layer signaling may be referred to as “L1/L2 (Layer 1/Layer 2) control information (L1/L2 control signals),” “L1 control information (L1 control signal)” and so on. Also, RRC signaling may be referred to as “RRC messages,” and can be, for example, an “RRC connection setup message,” “RRC connection reconfiguration message,” and so on. Also, MAC signaling may be reported using, for example, MAC control elements (MAC CEs (Control Elements)).

Also, reporting of predetermined information (for example, reporting of information to the effect that “X holds”) does not necessarily have to be sent explicitly, and can be sent in an implicit way (for example, by not reporting this piece of information, by reporting another piece of information, and so on). Decisions may be made in values represented by 1 bit (0 or 1), may be made in Boolean values that represent true or false, or may be made by comparing numerical values (for example, comparison against a predetermined value).

Software, whether referred to as “software,” “firmware,” “middleware,” “microcode,” or “hardware description language,” or called by other names, should be interpreted broadly, to mean instructions, instruction sets, code, code segments, program codes, programs, subprograms, software modules, applications, software applications, software packages, routines, subroutines, objects, executable files, execution threads, procedures, functions, and so on.

Also, software, commands, information and so on may be transmitted and received via communication media. For example, when software is transmitted from a website, a server or other remote sources by using wired technologies (coaxial cables, optical fiber cables, twisted-pair cables, digital subscriber lines (DSL) and so on) and/or wireless technologies (infrared radiation, microwaves and so on), these wired technologies and/or wireless technologies are also included in the definition of communication media.

The terms “system” and “network” as used herein are used interchangeably.

As used herein, the terms “base station (BS),” “radio base station,” “eNB,” “gNB,” “cell,” “sector,” “cell group,” “carrier,” and “component carrier” may be used interchangeably. A base station may be referred to as a “fixed station,” “NodeB,” “eNodeB (eNB),” “access point,” “transmission point,” “receiving point,” “femto cell,” “small cell” and so on.

A base station can accommodate one or more (for example, three) cells (also referred to as “sectors”). When a base station accommodates a plurality of cells, the entire coverage area of the base station can be partitioned into multiple smaller areas, and each smaller area can provide communication services through base station subsystems (for example, indoor small base stations (RRHs (Remote Radio Heads))). The term “cell” or “sector” refers to part or all of the coverage area of a base station and/or a base station subsystem that provides communication services within this coverage.

As used herein, the terms “mobile station (MS)” “user terminal,” “user equipment (UE)” and “terminal” may be used interchangeably.

A mobile station may be referred to, by a person skilled in the art, as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other suitable terms.

Furthermore, the radio base stations in this specification may be interpreted as user terminals. For example, each example/embodiment of this disclosure may be applied to a configuration in which communication between a radio base station and a user terminal is replaced with communication among a plurality of user terminals (D2D (Device-to-Device)). In this case, user terminals 20 may have the functions of the radio base stations 10 described above. In addition, terms such as “uplink” and “downlink” may be interpreted as “side.” For example, an “uplink channel” may be interpreted as a “side channel.”

Likewise, the user terminals in this specification may be interpreted as radio base stations. In this case, the radio base stations 10 may have the functions of the user terminals 20 described above.

Certain actions which have been described in this specification to be performed by base stations may, in some cases, be performed by their upper nodes. In a network comprised of one or more network nodes with base stations, it is clear that various operations that are performed so as to communicate with terminals can be performed by base stations, one or more network nodes (for example, MMEs (Mobility Management Entities), S-GWs (Serving-Gateways) and so on may be possible, but these are not limiting) other than base stations, or combinations of these.

The aspects/embodiments illustrated in this specification may be used individually or in combinations, which may be switched depending on the mode of implementation. The order of processes, sequences, flowcharts and so on that have been used to describe the aspects/embodiments herein may be re-ordered as long as inconsistencies do not arise. For example, although various methods have been illustrated in this specification with various components of steps in exemplary orders, the specific orders that are illustrated herein are by no means limiting.

The aspects/embodiments illustrated in this specification may be applied to LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR (New Radio), NX (New radio access), FX (Future generation radio access), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), systems that use other adequate radio communication systems and/or next-generation systems that are enhanced based on these.

The phrase “based on” as used in this specification does not mean “based only on” unless otherwise specified. In other words, the phrase “based on” means both “based only on” and “based at least on.”

Reference to elements with designations such as “first,” “second,” and so on as used herein does not generally limit the number/quantity or order of these elements. These designations are used herein only for convenience, as a method for distinguishing between two or more elements. In this way, reference to the first and second elements does not imply that only two elements may be employed, or that the first element must precede the second element in some way.

The terms “judge” and “determine” as used herein may encompass a wide variety of actions. For example, to “judge” and “determine” as used herein may be interpreted to mean making judgements and determinations related to calculating, computing, processing, deriving, investigating, looking up (for example, searching a table, a database or some other data structure), ascertaining and so on. Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on. In addition, to “judge” and “determine” as used herein may be interpreted to mean making judgements and determinations related to resolving, selecting, choosing, establishing, comparing, and so on. In other words, to “judge” and “determine” as used herein may be interpreted to mean making judgements and determinations related to some action.

As used herein, the terms “connected” and “coupled,” or any variation of these terms, mean all direct or indirect connections or coupling between two or more elements, and may include the presence of one or more intermediate elements between two elements that are “connected” or “coupled” to each other. The coupling or connection between the elements may be physical, logical, or a combination of these. For example, “connection” may be interpreted as “access.”

As used herein, when two elements are connected, these elements may be considered “connected” or “coupled” to each other by using one or more electrical wires, cables, and/or printed electrical connections, and, as a number of non-limiting and non-inclusive examples, by using electromagnetic energy having wavelengths of the radio frequency region, the microwave region and/or the optical region (both visible and invisible).

In the present specification, the phrase “A and B are different” may mean “A and B are different from each other.” The terms such as “leave,” “coupled” and the like may be interpreted as well.

When terms such as “include,” “comprise” and variations of these are used in this specification or in claims, these terms are intended to be inclusive, in a manner similar to the way the term “provide” is used. Furthermore, the term “or” as used in this specification or in claims is intended to be not an exclusive disjunction.

Now, although the present invention has been described in detail above, it should be obvious to a person skilled in the art that the present invention is by no means limited to the embodiments described herein. The present invention can be implemented with various corrections and in various modifications, without departing from the spirit and scope of the present invention defined by the recitations of claims. Consequently, the description herein is provided only for the purpose of explaining examples, and should by no means be construed to limit the present invention in any way.

1. A user terminal comprising:
a receiving section that receives downlink control information;
a transmission section that transmits an uplink signal based on the downlink control information; and
a control section that changes interpretation of a specific field, included in the downlink control information, depending on whether a waveform to apply to the uplink signal has already been indicated or not.

2. The user terminal according to claim 1, wherein, if the waveform to apply to the uplink signal has already been indicated, the control section interprets that the specific field shows information about a rank.

3. The user terminal according to claim 2, wherein:
if the waveform to apply to the uplink signal has already been indicated, the control section interprets that the specific field shows a rank group comprised of one or more ranks; and
the transmission section uses one of the ranks in the rank group to transmit the uplink signal based on another field included in the downlink control information.

4. The user terminal according to claim 3, wherein the rank group accommodates different numbers of ranks depending on the value of the specific field.

5. The user terminal according to claim 1, wherein, when the waveform to apply to the uplink signal is indicated and a signal to command resetting of the waveform is reported later, the control section interprets that the specific field shows information about the waveform.

6. A radio communication method comprising the steps of:
receiving downlink control information;
transmitting an uplink signal based on the downlink control information; and
changing interpretation of a specific field, included in the downlink control information, depending on whether a waveform to apply to the uplink signal has already been indicated or not.

7. The user terminal according to claim 2, wherein, when the waveform to apply to the uplink signal is indicated and a signal to command resetting of the waveform is reported later, the control section interprets that the specific field shows information about the waveform.

8. The user terminal according to claim 3, wherein, when the waveform to apply to the uplink signal is indicated and a signal to command resetting of the waveform is reported later, the control section interprets that the specific field shows information about the waveform.

9. The user terminal according to claim 4, wherein, when the waveform to apply to the uplink signal is indicated and a signal to command resetting of the waveform is reported later, the control section interprets that the specific field shows information about the waveform.
